(19) United States
(12) Patent Application Publication
(10) Pub. No.: US 2005/0134130 A1
(43) Pub. Date: Jun. 23, 2005

(54) Motor with wavelike casing

(76) Inventors: Ming-Ta Tsai, Taipei Hsien (TW); Yung-Hsiang Kuo, Taipei Hsien (TW); Zong-Ming Lin, Taipei Hsien (TW)

Correspondence Address: Ming-Ta Tsai, 235 Chung-Ho, P.O. Box 10-69, Taipei, TW

(21) Appl. No.: 10/950,289

(22) Filed: Sep. 27, 2004

(30) Foreign Application Priority Data
Dec. 23, 2003 (TW) 092222509

(51) Int. Cl. H02K 9/00; H02K 11/00; H02K 5/10

(52) U.S. Cl. 310/89; 310/58; 310/71

(57) ABSTRACT

A motor comprises a casing having a plurality of slots; an interior of the casing having a coil which is formed by winding enamel-insulated wires; an inner cover; an outer cover locked to the casing and the inner cover; and a rotor placed within the casing and fixed to be between the outer cover and the casing by a bearing; an inner diameter of the casing being matched to the diameter of the rotor; a very small gap being formed between the rotor and the casing so that the rotor is rotatable therein. An outer side of the casing has wavelike textures. External air is guided into the wave like textures so by the texture of the casing. Air flows along the texture so as to have predetermined heat dissipating effect, dust proof effect and water proof effect.

### FIELD OF THE INVENTION

The present invention relates to motors, and particularly to a motor with a wavelike casing for guiding airflow so that by the texture of the casing, the wind flows along guide directions so as to have preferred heat dissipating effect, dust proof effect and water proof effect.

### BACKGROUND OF THE INVENTION

With reference to FIG. 1, in the prior art motor 1, no water proof design at a portion for guiding the electric wire 12 into a power hole 11. Thereby in the prior art, the coil and rotor are integrally formed. As the motor is destroyed, the whole motor is deserted. Thereby the use of the prior art motor is inconvenient, but also it induces the problem of environmental pollution.

### SUMMARY OF THE INVENTION

Accordingly, the primary object of the present invention is to provide a motor comprises a casing having a plurality of slots; an interior of the casing having a coil which is formed by winding enamel-insulated wires; an inner cover; an outer cover locked to the casing and the inner cover; and a rotor placed within the casing and fixed to be between the outer cover and the casing by a bearing; an inner diameter of the casing being matched to the diameter of the rotor; a very small gap being formed between the rotor and the casing so that the rotor is rotatable therein. An outer side of the casing has wavelike textures. External air is guided into the wave like textures so by the texture of the casing. Air flows along the texture so as to have predetermined heat dissipating effect, dust proof effect and water proof effect.

The various objects and advantages of the present invention will be more readily understood from the following detailed description when read in conjunction with the appended drawing.

### BRIEF DESCRIPTION OF THE DRAWINGS

FIG. 1 is a perspective view of a prior art motor.

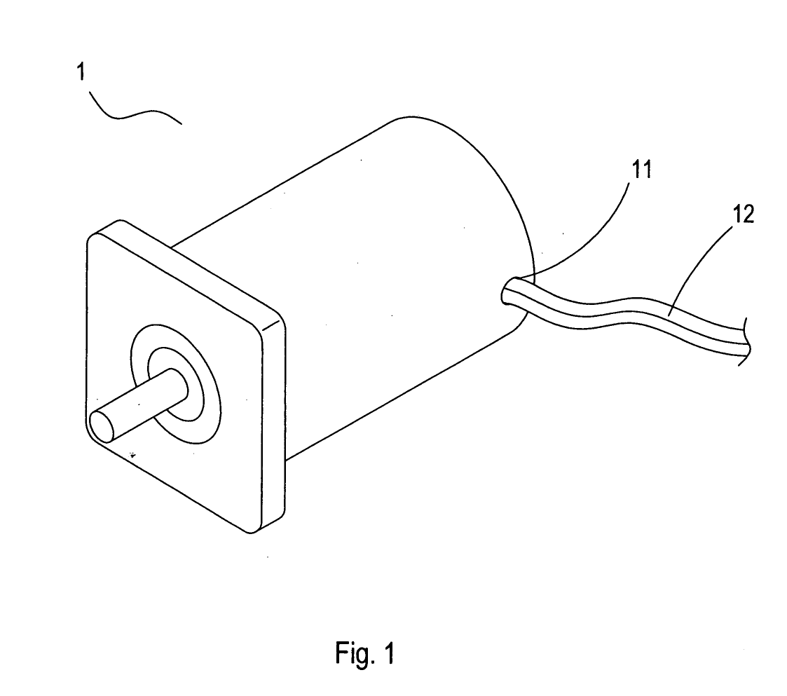

FIG. 2 is an exploded perspective view of the present invention.

FIG. 3 is an enlarged view of the waterproof pads of the present invention.

FIG. 4 is a schematic view showing the airflow according to the present invention.

FIG. 5 is an assembled perspective view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

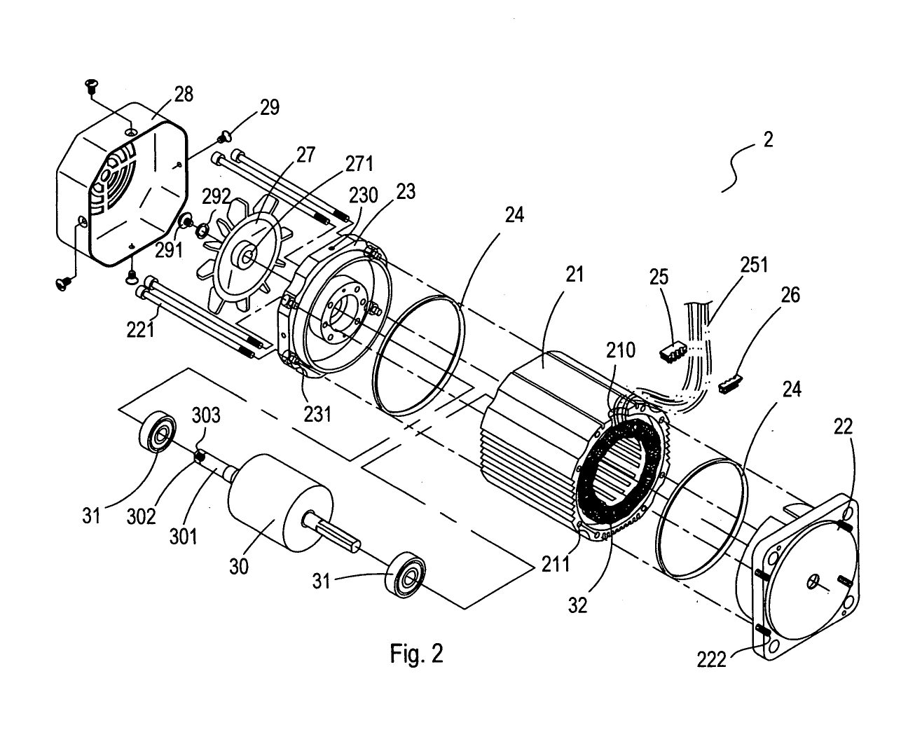

With reference to FIG. 2, the motor 2 of the present invention has the following structure.

A casing 21 has a plurality of slots. An interior of the casing 21 has a coil 32 which is formed by winding enamel-insulated wires.

An inner cover 23 is includes.

An outer cover 22 is includes. A plurality of screws 221 pass through the through holes 231 of the inner cover 23, the through holes 21 of the casing 21 and the screw holes 222 of the outer cover 22 so as to lock the outer cover 22, the casing 21 and the inner cover 23.

A rotor 30 is placed within the casing 21 and is fixed to be between the outer cover 23 and the casing 21 by a bearing 31. An inner diameter of the casing 21 is matched to the diameter of the rotor 30. A very small gap is formed between the rotor 30 and the casing 21 so that the rotor 30 can rotate therein.

An O ring 24 is installed between the casing 21, the inner cover 23 and the outer cover 22 for tightly adhering the casing 21, inner cover 23 and the outer cover 22. Not only the object of waterproof is achieved, but also the noise is isolated.

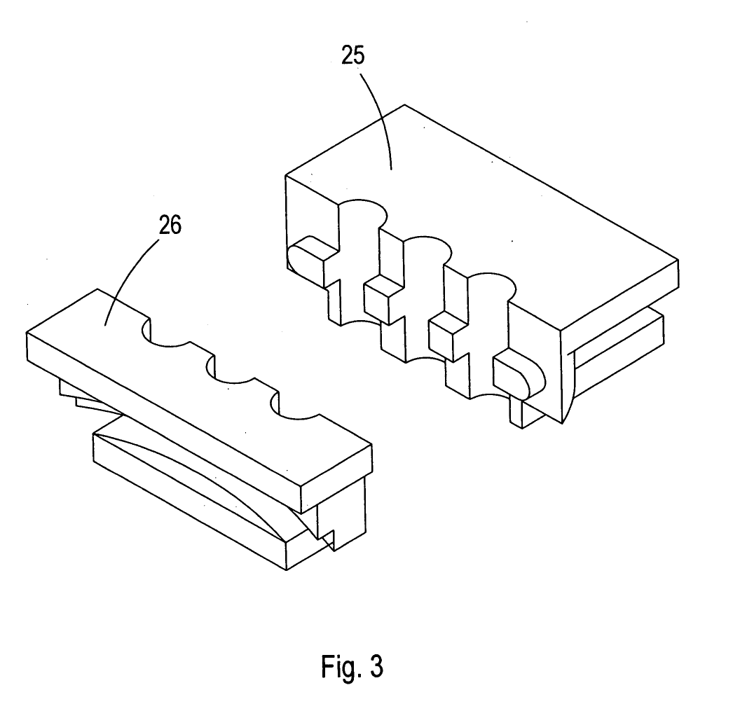

Two water-proof pads 25, 26 are installed at a notch 210 at an upper edge of the casing, see FIG. 3. The waterproof pads 25, 26 are combinable. An electrical wire 251 is tightly enclosed in a recess formed by the two waterproof pads 25, 26 so as to achieve the object of waterproof.

A spindle 301 of the rotor 30 passes through the inner cover 23 through the bearing 31 to be combined with a via hole 271 of a fan 27. A screw 291 passes through the washer 292 and then is locked to the screw hole 303 of the spindle 301. Two lateral sides 302 of the spindle 301 are exactly combined to the wall of the via hole 271 of the fan 27. Thereby the operation of the motor will drive the fan 27 to rotate. A fan cover 28 is installed on one outer side of the casing 21 opposite to the outer cover 22. The fan cover 28 is locked to the casing 21 by locking screws 29 to the screw holes 230 of the inner cover 23. Thereby the rotation of the fan 27 will be protected.

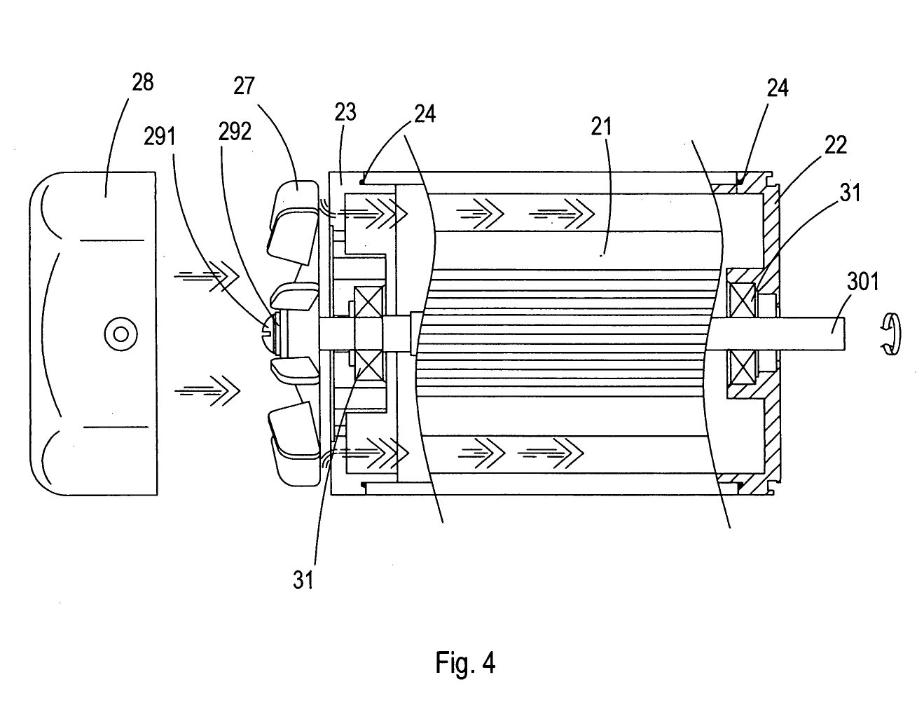

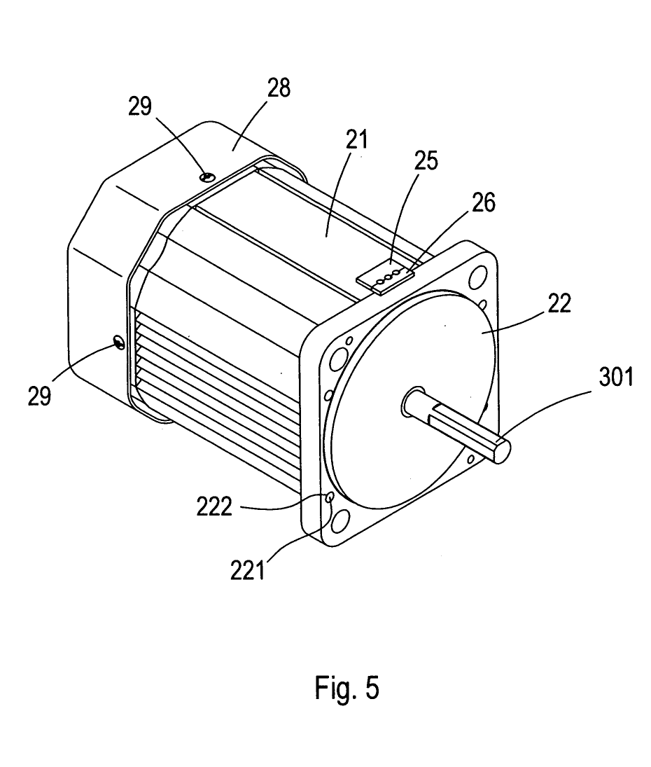

With reference to FIGS. 4 and 5, when the fan 27 of the present invention is assembled into a rotor 30, external air will be guided into a wave like shape casing 21 so that wind flows as the indication. Thereby by the texture of the casing 21, the wind flows along guide directions so as to have preferred heat dissipating effect, dust proof effect and waterproof effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A motor comprising:
a casing having a plurality of slots; an interior of the casing having a coil which is formed by winding enamel-insulated wires;
an inner cover;
an outer cover locked to the casing and the inner cover; and
a rotor placed within the casing and fixed to be between the outer cover and the casing by a bearing; an inner diameter of the casing being matched to the diameter of the rotor; a very small gap being formed between the rotor and the casing so that the rotor is rotatable therein.

2. The motor as claimed in claim 1, wherein a spindle of the rotor passes through the inner cover through the bearing to be combined with a via hole of a fan; and a screw passes through the washer and then is locked to the screw hole of the spindle.

3. The motor as claimed in claim 2, wherein two lateral sides of the spindle are exactly combined to the wall of the via hole of the fan.

4. The motor as claimed in claim 1, wherein an O ring is installed between the casing; the inner cover and the outer cover for tightly adhering the casing, inner cover and the outer cover; not only the object of waterproof is achieved, but also the noise is isolated.

5. The motor as claimed in claim 1, wherein a fan cover is installed on one outer side of the casing opposite to the outer cover; the fan cover is locked to the casing by screws.

6. The motor as claimed in claim 1, wherein two waterproof pads are installed at notches at an upper edge of the casing; and the water-proof pads are combinable; an electrical wire is tightly enclosed in a recess formed by the two waterproof pads so as to achieve the object of waterproof.

7. The motor as claimed in claim 1, wherein an outer side of the casing has wavelike textures; external air is guided into the wavelike textures; by the texture of the casing, air flows along the texture so as to have predetermined heat dissipating effect, dust proof effect and water proof effect.
